(19) United States
(12) Patent Application Publication
(10) Pub. No.: US 2019/0284854 A1
(43) Pub. Date: Sep. 19, 2019

(54) SUPPLEMENTAL DOOR LOCK AND BREACH TOOL

(71) Applicant: FIRE DOOR SOLUTIONS LLC, Stilwell, KS (US)

(72) Inventors: David Linn Geenens, Lenexa, KS (US); Jeffrey Lynn Perry, Overland Park, KS (US)

(73) Assignee: FIRE DOOR SOLUTIONS LLC, Stilwell, KS (US)

(21) Appl. No.: 16/354,462

(22) Filed: Mar. 15, 2019

Related U.S. Application Data
(60) Provisional application No. 62/644,151, filed on Mar. 16, 2018.
(60) Provisional application No. 62/644,144, filed on Mar. 16, 2018.
(60) Provisional application No. 62/644,115, filed on Mar. 16, 2018.

(51) Int. Cl. E05C 19/00; E05C 1/04

(52) U.S. Cl. CPC E05C 19/003; E05Y 2900/132; E05C 1/04

(57) ABSTRACT

A breach tool for unlocking a supplemental door lock mounted on a lower edge of a first side of a door comprises a handle section, a first hinged section, and a second hinged section. The handle section includes a first panel and a second panel connected to the first panel. The first hinged section includes a first hinge that rotatably joins the first hinged section to the first panel of the handle section and a tab extending outward from the first hinged section at roughly a right angle. The tab is positioned opposite from the first hinge. The second hinged section includes a second hinge that rotatably joins the second hinged section to the first hinged section and an upturned edge positioned opposite the second hinge. The breach tool is configured to be pushed under the door to raise a locking feature to unlock the supplemental door lock.

### RELATED APPLICATIONS

The current patent application is a utility patent application which claims priority benefit with regard to all common subject matter to U.S. Provisional Application Ser. No. 62/644,151, titled “SUPPLEMENTAL DOOR LOCK”, filed Mar. 16, 2018; U.S. Provisional Application Ser. No. 62/644,144, titled “SUPPLEMENTAL DOOR LOCK AND BREACH TOOL”, filed Mar. 16, 2018; and U.S. Provisional Application Ser. No. 62/644,115, titled “SUPPLEMENTAL DOOR LOCK AND ALERT SYSTEM”, filed Mar. 16, 2018. The listed earlier-filed provisional applications are hereby incorporated by reference in their entireties into the current patent application.

### FIELD OF THE INVENTION

Embodiments of the current invention relate to door barriers, door locks, and similar devices. More particularly, the invention relates to a supplemental door lock which is deployed in emergency situations to prevent a door from being opened by an attacker, intruder, etc., and to a tool that unlocks the supplemental door lock.

### DESCRIPTION OF THE RELATED ART

Mass shootings and other attacks in schools, offices, and other buildings are occurring more frequently. To minimize deaths and injuries during such attacks, students, teachers, and other occupants are trained to hide behind locked doors until law enforcement arrives. Unfortunately, many schools and other buildings don't have lockable doors or have locks that are easy to circumvent.

To provide better protection against such attacks, many types of supplemental door locks, barriers, and barricades have been developed. Unfortunately, some of these devices are too flimsy or otherwise easy to circumvent; some require special knowledge to deploy; some can't be deployed quickly enough; and/or some have stand-alone components that must be stored in closets or on shelves when not in use and then retrieved and deployed during emergencies. More seriously, some prior art devices do not comply with fire and safety codes because they can't be unlocked or otherwise circumvented by law enforcement personnel or other first responders. This is a problem in the event a threat is inside a locked room, the occupants of a locked room are incapacitated or otherwise unable to deactivate the lock, and/or the lock is misused.

Accordingly, there is a need for an improved supplemental door lock that overcomes these and/or other limitations of prior art devices.

This background discussion is intended to provide information related to the present invention which is not necessarily prior art.

### SUMMARY OF THE INVENTION

Embodiments of the current invention solve the above-mentioned problems and provide an improved supplemental door lock for securely locking a door during emergencies and a breach tool to unlock the supplemental door lock. The supplemental door lock is designed to be installed on the inside face of a door and an adjacent floor and is quickly and easily shiftable between an unlocked position in which the door may freely open (if no other locks or latches are deployed) and a locked position to prevent an attacker, intruder, etc. from opening the door. The supplemental door lock is fabricated from strong and durable materials; is nearly impossible to circumvent; is easy to install; has no unattached components that must be stored when not in use; can be deployed in seconds by anyone with no training; and complies with all known fire and safety codes.

The breach tool includes at least a first section and a second section that are joined to one another with a hinge. At the edge of one of the sections adjacent to the hinge is an outward-extending tab. The breach tool is slid under the door on the floor toward the supplemental door lock. The tab contacts the floor and elevates the hinge. The second section and the hinge slide under a locking feature of the supplemental door lock and raise it—unlocking the lock in the process.

An embodiment of the breach tool broadly comprises a handle section, a first hinged section, and a second hinged section. The handle section includes a first panel and a second panel connected to the first panel at roughly a right angle. The first hinged section includes a first hinge that rotatably joins the first hinged section to the first panel of the handle section and a tab extending outward from the first hinged section at roughly a right angle. The tab is positioned opposite from the first hinge. The second hinged section includes a second hinge that rotatably joins the second hinged section to the first hinged section and an upturned edge positioned opposite the second hinge. The breach tool is configured to be pushed under the door along a floor such that the first and second hinged sections pass from a second side to the first side and the second hinge engages a locking feature of the supplemental door lock, raising the locking feature to unlock the supplemental door lock.

Another embodiment of the current invention provides a breach tool for unlocking a supplemental door lock mounted on a lower edge of a first side of a door. The breach tool broadly comprises a handle section, a first hinged section, and a second hinged section. The handle section includes a first panel and a second panel connected to the first panel at roughly a right angle. The first hinged section includes a first hinge that rotatably joins the first hinged section to the first panel of the handle section and a tab extending outward from the first hinged section at roughly a right angle. The tab is positioned opposite from the first hinge. The second hinged section includes a second hinge that rotatably joins the second hinged section to the first hinged section and an upturned edge positioned opposite the second hinge. The breach tool is configured to be pushed under the door along a floor such that the first and second hinged sections pass from a second side to the first side, the upturned edge is configured to contact a first component of the locking feature and the second hinge is configured to apply an upward force to a second component of the locking feature, the first and second hinged sections are configured to rotate about the second hinge as the second hinge applies the upward force to the second component of the locking feature, and the first hinged section is configured to rotate about the first hinge as the second hinge applies the upward force to the second component of the locking feature.

Yet another embodiment of the current invention provides a supplemental door lock and breach tool system comprising a supplemental door lock and a breach tool. The supplement door lock includes a door-mounted component and a floor-mounted component. The door-mounted component is configured to be mounted on a door adjacent to a lower edge thereof and includes a locking assembly for locking the supplemental door lock with a hinge pin, a locking blade, and a locking post. The hinge pin is configured to be rotated between an unlocked position and a locked position. The locking blade includes a tab along a first edge of the locking blade such that the tab is attached to the hinge pin. The locking blade is configured to travel downward into a locking groove when the hinge pin is rotated from the unlocked position to the locked position. The locking post is attached to the locking blade along a second edge opposite the hinge pin and is oriented in a vertical fashion and extends downward from the locking blade. The floor-mounted component is to be mounted on a floor in alignment with the door-mounted component when the door is in a closed position. The floor-mounted component includes a floor plate configured to attach to the floor and a slot configured to retain the locking post when the hinge pin is in the locked position.

The breach tool comprises a handle section, a first hinged section, and a second hinged section. The handle section includes a first panel and a second panel connected to the first panel at roughly a right angle. The first hinged section includes a first hinge that rotatably joins the first hinged section to the first panel of the handle section and a tab extending outward from the first hinged section at roughly a right angle. The tab is positioned opposite from the first hinge. The second hinged section includes a second hinge that rotatably joins the second hinged section to the first hinged section and an upturned edge positioned opposite the second hinge. The breach tool is configured to be pushed under the door along a floor such that the first and second hinged sections pass from a second side to the first side and the second hinge engages a locking feature of the supplemental door lock, raising the locking feature to unlock the supplemental door lock.

### BRIEF DESCRIPTION OF THE DRAWING FIGURES

Embodiments of the current invention are described in detail below with reference to the attached drawing figures, wherein:

FIG. 1 is a perspective view of a supplemental door lock, constructed in accordance with various embodiments of the current invention, shown with a fragmentary view of a door and a fragmentary view of a floor, the supplemental door lock being implemented in its operating environment and including a door-mounted component mounted to the door and a floor-mounted component mounted to the floor, wherein the supplemental door lock is in an unlocked state;

FIG. 2 is a perspective view of the supplemental door lock of FIG. 1, wherein a locking assembly of the door-mounted component is rotated such that a locking post is retained in the floor-mounted component, thereby placing the supplemental door lock in a locked state;

FIG. 3 is an exploded perspective view of the door-mounted component;

FIG. 4 is a perspective view of an alternative embodiment of a door-mounting plate of the door-mounted component;

FIG. 5 is a perspective view of a breach tool, constructed in accordance with additional embodiments of the current invention and configured to unlock the supplemental door lock;

FIG. 6 is a side view of the breach tool and the supplemental door lock mounted on a door and in the locked state, the breach tool in a first phase of unlocking the supplemental door lock;

FIG. 7 is a side view of the breach tool and the supplemental door lock, the breach tool in a second phase of unlocking the supplemental door lock; and

FIG. 8 is a side view of the breach tool and the supplemental door lock, the breach tool in a final phase of unlocking the supplemental door lock.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

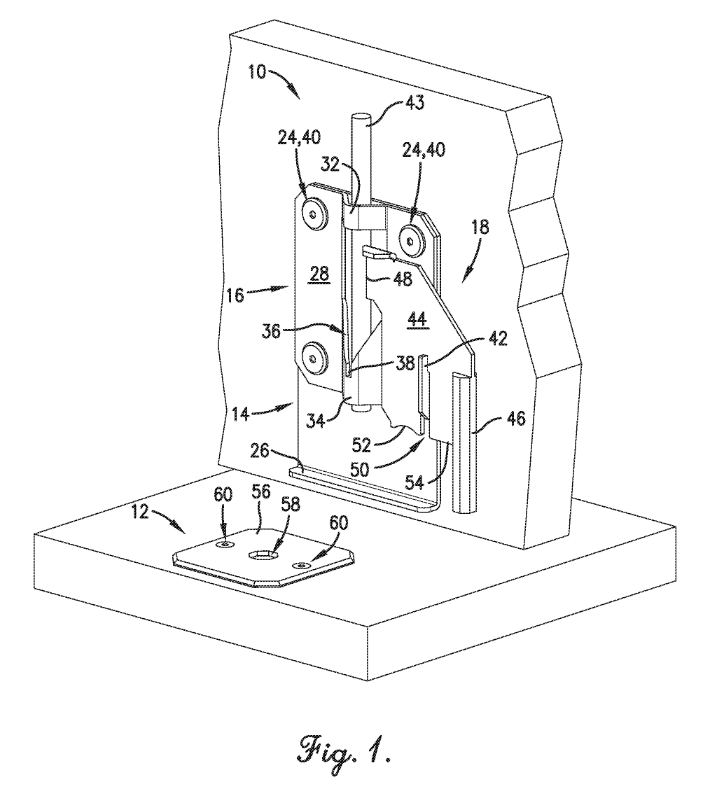

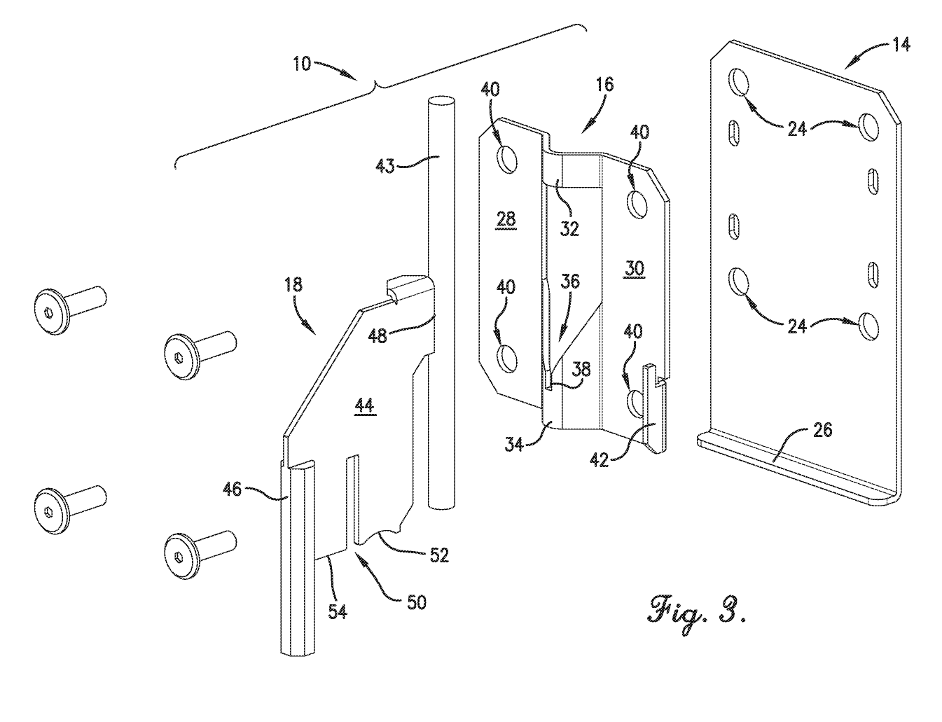

Referring to FIGS. 1-3, a supplemental door lock constructed in accordance with embodiments of the present invention broadly comprises a door-mounted component 10 and a floor-mounted component 12. As explained in more detail below, the supplemental door lock is shiftable between an unlocked position in which its door may freely open (if no other locks or latches are deployed) and a locked position in which the door-mounted component 10 engages the floor mounted component 12 to prevent opening of the door.

The door-mounted component 10 comprises a door mounting plate 14; an hinge plate 16; and a locking assembly 18 sandwiched between the door mounting plate 14 and the hinge plate 16. All of these components are preferably fabricated of stainless steel or other hardened metals.

The door mounting plate 14 mounts to the inside face of a door and includes several bolt-holes 24 formed in the door mounting plate 14 for receiving screws or other fasteners. A perpendicularly-extending foot 26 is formed on the lower edge of the door mounting plate 14. The purpose of the foot 26 is described below.

An exemplary embodiment of the door mounting plate 14 is approximately 8″ tall, 5″ wide, and 0.25″ thick. An exemplary embodiment of the foot 26 extends approximately 0.625″ from the lower edge of the door mounting plate. However, the door mounting plate 14 and its foot 26 may be formed in other shapes and sizes without departing from the scope of the invention.

An alternative embodiment of the door mounting plate 14 is shown in FIG. 4 and has a generally rectangular-shaped periphery with an inverted T-shaped cutout 20 and a corresponding T-shaped insert 22 that may be placed in the cutout 22. Labels or stickers, that are high contrast, high visibility, and/or reflective, with messaging such as “ACTIVE”, may be applied to the insert 22 and covered by the locking assembly 18 when the supplemental door lock is in an unlocked position and exposed when the supplemental door lock is in a locked position to designate the status of the supplemental door lock.

An exemplary embodiment of the hinge plate 16 mounts over the door mounting plate 14 so as to envelop the locking assembly 18 therebetween. The hinge plate 16 includes left and right planar sections 28, 30 joined by spaced apart upper and lower bridges 32, 34. The upper and lower bridges 32, 34 create open spaces between the door mounting plate 14 and the hinge plate 16 for receiving and accommodating movement of the locking assembly 18 as described in more detail below. Each bridge 32, 34 is formed by first and second roughly planar sections that are joined by an arcuate or curved section. The first and second planar sections are positioned to form an angle of roughly 90 degrees. The lower bridge 34 includes a funnel-shaped, or V-shaped, groove 36 that terminates in a first vertical slot 38, the purpose of which are described below. Several bolt-holes 40 are formed in the hinge plate 16 and can be aligned with the bolt holes 24 in the door mounting plate 14 so that both sets of bolt holes 24, 40 can receiving the same screws or other fasteners. A support arm 42 extends from either the left or right planar sections of the hinge plate 16 to form a second vertical slot, the purpose of which is described below.

An exemplary embodiment of the hinge plate 16 is approximately 5.5″ tall, 6″ wide, and 0.25″ thick, but it may be formed in other shapes and sizes without departing from the scope of the invention.

An exemplary embodiment of the locking assembly 18 is sandwiched between the door mounting plate 14 and the hinge plate 16 and is shiftable between unlocked and locked positions as described below. An embodiment of the locking assembly 18 includes an elongated hinge pin 43, a locking blade 44 fixed to the hinge pin 43, and a locking post 46 extending from the locking blade 44.

The hinge pin 43 is positioned underneath the upper and lower bridges 32, 34 of the hinge plate 16 and can be shifted vertically up and down and rotated relative to the door mounting plate 14 and the hinge plate 16. An embodiment of the hinge pin 43 is circular in cross-section, 0.5″ in diameter, and 8.125″ tall, but it may be of any size and shape.

The locking blade 44 has a tab 48 that is welded or otherwise fastened to the central portion of the hinge pin 43 such that the locking blade 44 extends outwardly from the hinge pin 43 and rotates with the hinge pin 43. A third vertical slot 50 extends upwardly from the lower edge of the locking blade 44, the purpose of which is described below. The vertical slot 50 divides the lower edge of the locking blade 44 into an inner edge portion 52 and an outer edge portion 54. The inner edge portion 52 is concave-shaped.

The locking post 46 is attached to, and extends downward from, the outer edge portion 54 of the locking blade 44. The locking post 46 may be oriented along a vertical axis parallel an axis of the hinge pin 43. The locking post 46 couples with the floor-mounted component 12 when the locking assembly 18 is shifted to its locked position, as described in more detail below. An exemplary embodiment of the locking post 46 is hexagonal in cross-section, 0.625″ wide at its base, and 3.75″ tall. The locking post 46 may have other cross-sectional shapes including geometric shapes such as circular, oval, triangular, rectangular, square, pentagonal, and so forth. The shape and size of the locking post 46 prevents it from rotating in the floor-mounted component 12 and provides a solid anchor against inward or outward force exerted on the door by an attacker or intruder as described in more detail below.

The floor-mounted component 12 mounts to the floor in front of the door-mounted component 10. An embodiment of the floor-mounted component 12 comprises a floor plate 56 with a hexagonal-shaped slot 58 for receiving the end of the hexagonal-shaped locking post 46 when the locking assembly 18 is shifted to its locked position. An embodiment of the floor plate 56 is square-shaped with angled, beveled edges and is approximately 3.875″ long and wide, but it may be of any size and shape. The floor plate 56 includes a pair of bolt holes 60 for receiving screws or other fasteners. The floor plate 56 is also preferably fabricated of stainless steel or other hardened metals.

To install the supplemental door lock, the locking assembly 18 is placed between the door mounting plate 14 and the hinge plate 16, and the assembled components are then fastened to the inside face of a door by driving screws or other fasteners through the aligned holes 24, 40. The floor plate 56 is then attached to a floor area in front of the door-mounted components by driving screws or other fasteners through the holes 60 in the plate. In addition, a hole in the floor that aligns with the slot 58 must be drilled. These steps may of course be reversed so that the floor-mounted component 12 is installed before the door-mounted component 10.

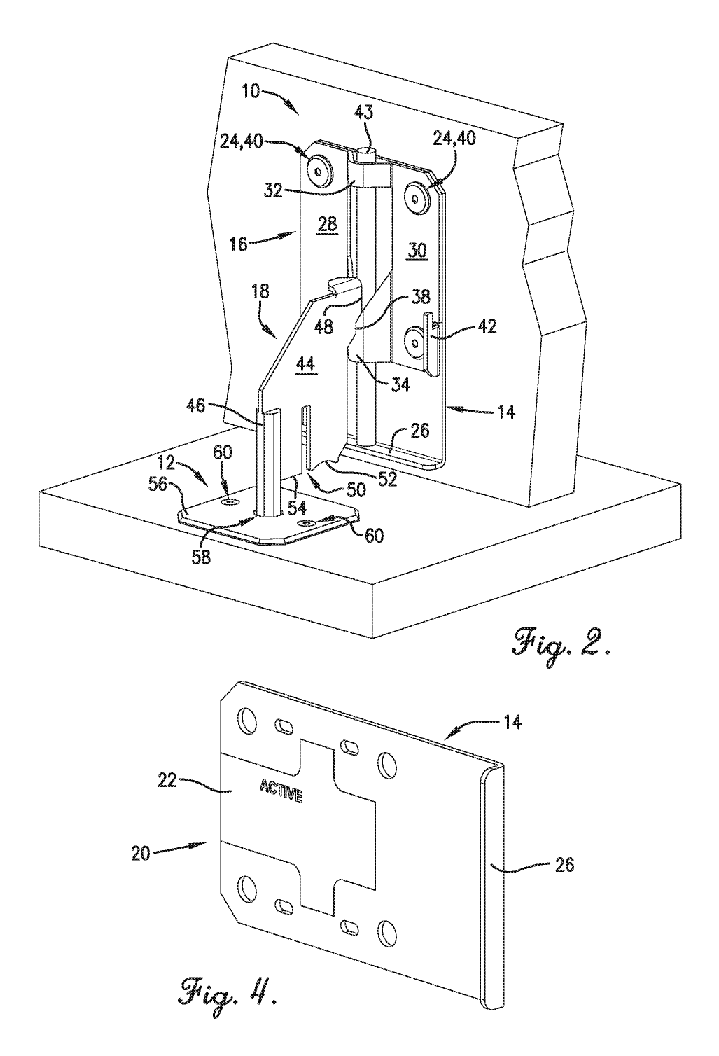

In use, the supplemental door lock may be shifted between an unlocked position in which the door may freely open (if no other locks or latches are deployed) and a locked position to prevent opening of the door from the outside. FIG. 1 shows the locking assembly 18 in its unlocked position in which the hinge pin 43 has been vertically raised and the hinge pin 43 and locking blade 44 have been rotated counter-clockwise such that locking blade 44 rests over the support arm 42 on the hinge plate 16. Referring to FIG. 2, to shift the locking assembly 18 to its locked position, the locking blade 44 and hinge pin 43 are raised to lift the locking blade 44 off the support arm 42. The hinge pin 43 and locking blade 44 are then rotated clockwise until the locking blade 44 is generally perpendicular to the door. The hinge pin 43 and locking blade 44 are then lowered until the locking post 46 enters the slot 58 in the floor plate 56. As the locking blade 44 is lowered, the funnel-shaped groove 36 in the hinge plate 16 guides and centers the locking blade 44 until the tab 48 of the locking blade 44 enters the vertical slot 38 at the bottom of the funnel-shaped groove 36. In addition to guiding and centering the locking blade 44, the vertical slot 38 prevents the locking blade 44 from rotating when the locking blade 44 is in its lowermost position. Furthermore, when the locking assembly 18 is in the locked position, the bottom of the hinge pin 43 may rest on the foot 26 of the door mounting plate 14 in order to prevent the hinge pin 43 from extending into the gap between the door and the floor. (Ensuring that the gap between the door and the floor is unimpeded is important when security personnel are trying to unlock the supplemental door lock from the other side of the door after the emergency or crisis is over.) These steps may then be performed in reverse order to shift the supplemental door lock back to its unlocked position.

The above described supplemental door lock has numerous advantages. For example, the enlarged hexagonal shape of the locking post 46 and corresponding floor plate slot 58 prevent the hinge pin 43 and locking blade 44 from rotating when the supplemental door lock is shifted to its locked position. This keeps the locking blade 44 perpendicular to the door where it provides the maximum protection against inward or outward pressure on the door exerted by an attacker on the exterior side of the door.

Additionally, the funnel-shaped groove 36 in the hinge plate 16 guides and centers the locking blade 44 such that the locking post 46 finds its “home” in the corresponding slot 58 in the floor plate 56 without requiring a user to align the locking post 46 and slot 58. In fact, a user can simply lift the locking blade 44 off the support arm 42, rotate the locking blade 44 clockwise, and then drop it into the funnel-shaped slot 36 without further alignment. The vertical slot 38 at the bottom of the funnel-shaped slot 36 also cooperates with the tab 48 to prevent the hinge pin 43 and locking blade 44 from rotating when the supplemental door lock is shifted to its locked position. This further assists with keeping the locking blade 44 perpendicular to the door where it provides the maximum protection against inward or outward pressure on the door exerted by an attacker on the exterior side of the door.

In another embodiment of the invention, the above-described supplemental door lock may be combined with a novel breach tool that permits a law-enforcement officer or other authorized person to unlock the supplemental door lock from the outer side of the door. This satisfies fire codes and other safety regulations that require locks to have accessible keys in the event a threat is inside a locked room, the occupants of a locked room are incapacitated, and/or the lock is misused. While similar breach tools have been developed, the breach tool of the present invention is uniquely configured to work with the supplemental door lock described above.

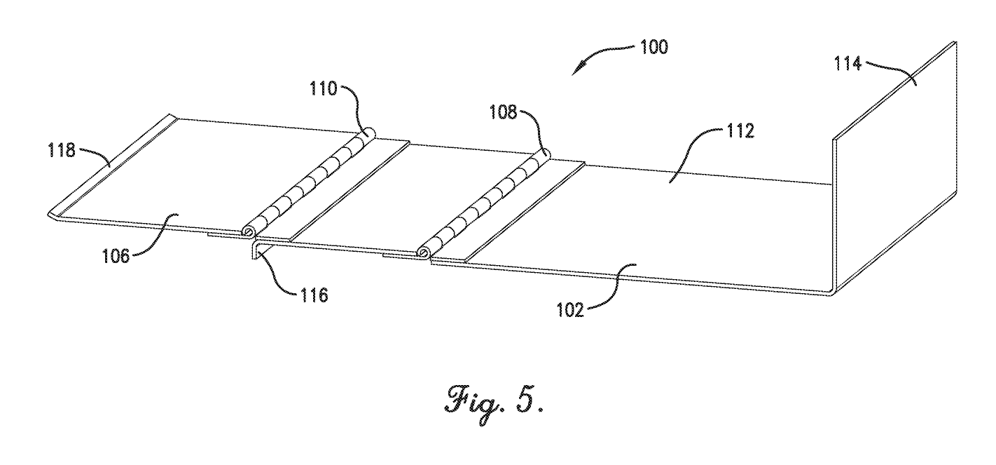

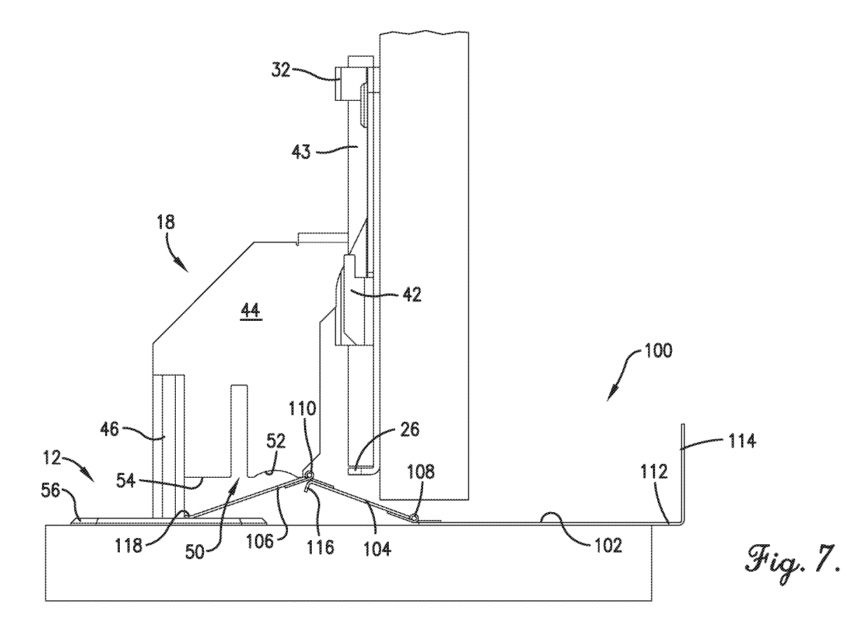

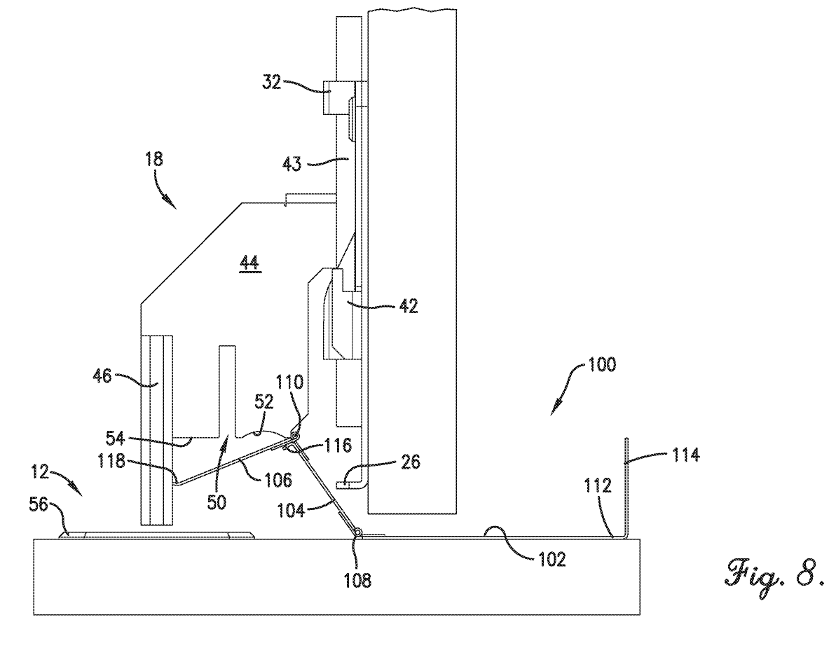

An exemplary embodiment of the breach tool 100 is illustrated in FIGS. 5-8 and comprises an L-shaped handle portion 102 connected to first and second hinged sections 104, 106 by first and second hinges 108, 110. Although the illustrated breach tool is shown with two hinged sections and two hinges, it may have any number of hinged sections and hinges.

An exemplary embodiment of the handle section 102 includes a planar, rectangular first panel 112 that is approximately 5.25″ long and 5″ wide and an upturned gripping second panel 114 connected to the first panel 112 at a right angle that is approximately 5″ wide and 2″ tall.

The first hinged section 104, which is closest to the handle section 102 and rotatably joined thereto by the first hinge 108, is approximately 2.125″ long and 5″ wide, and the second hinged section 106, which is furthest from the handle section 102 and rotatably joined to the first hinged section 104 by the second hinge 110, is approximately 2.515″ long and 5″ wide.

The second hinged section 106 has an upturned outer edge 118, to allow it to easily slide across the floor as described below. The first hinged section 104 has a down-turned tab 116 extending outward at roughly a right angle and positioned at an edge opposite from the first hinge 108 and adjacent to the second hinge 110, the purpose of which is described below.

When not in use, the breach tool 100 may be folded along the hinges 108, 110 so the hinged sections 104, 106 partially overlay the handle section 102. This allows the breach tool to be folded relatively flat, except for the gripping panel 114 of the handle section 102, so the breach tool 100 can be carried in a first responder's pocket or bag.

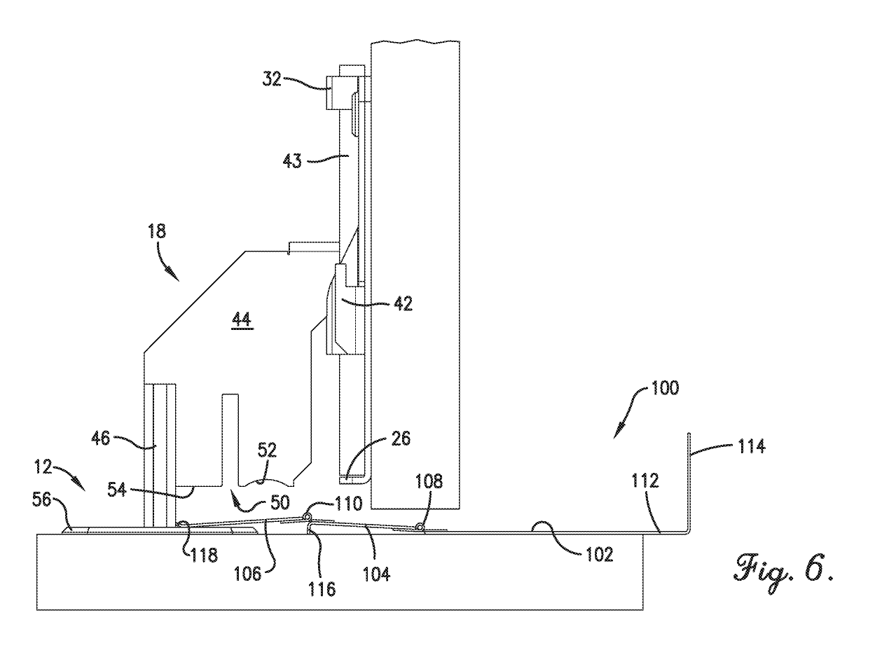

Referring to FIGS. 6-8, to use the breach tool 100 to unlock the supplemental door lock (which is mounted on a first side of the door), a first responder may unfold the hinged sections 104, 106 so that the breach tool 100 is flat except for the upturned gripping panel 114. The breach tool 100 is placed on the floor such that the downturned tab 116 contacts the floor. The flattened hinge sections 104, 106 and the hinges 108, 110 are then slid underneath the door from a second side to the first side on which the supplemental door lock is mounted. There is typically a gap between the bottom of the door and the floor which allows the breach tool 100 to pass therethrough. The forward upturned edge 118 may encounter the floor plate 56 of the floor-mounted component 12 and ride on top of the floor plate 56. The forward edge 118 may then contact the locking post 46. As the breach tool 100 is continuously pushed and the forward edge 118 is in contact with the locking post 46 and can no longer move, the first and second hinged sections 104, 106 are forced to rotate about the second hinge 110, which causes the second hinge 110 to rise upward from the floor. Simultaneously, the first hinged section 104 rotates about the first hinge 108, further contributing to the rise of the second hinge 110. The rising second hinge 110 comes into contact with the bottom of the locking blade 44—specifically, the concave-shaped inner edge 52. Continued pushing on the second panel 114 results in continued rising of the second hinge 110 and an upward force applied to the locking blade 44. The second hinge 110 may ride forward along the inner edge 52 as it pushes the locking blade 44 upward. The upward force on the locking blade 44 also raises the locking post 46 upward from the slot 58 of the floor plate 56. The breach tool 100 is further pushed forward until the bottom of the locking post 46 is above the floor plate 56. At that point, the supplemental door lock is effectively unlocked and the first responder can open the door.

### ADDITIONAL CONSIDERATIONS

Although the present application sets forth a detailed description of numerous different embodiments, the legal scope of the description is defined by the words of the claims set forth in any regular utility patent applications or other patent applications that claim priority to this provisional application. The descriptions herein are to be construed as exemplary only and do not describe every possible embodiment since describing every possible embodiment would be impractical. Numerous alternative embodiments may be implemented, using either current technology or technology developed after the filing date of this patent application, which would still fall within the scope of the claims.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A breach tool for unlocking a supplemental door lock mounted on a lower edge of a first side of a door, the breach tool comprising:
a handle section including a first panel and a second panel connected to the first panel at roughly a right angle;
a first hinged section including a first hinge that rotatably joins the first hinged section to the first panel of the handle section and a tab extending outward from the first hinged section at roughly a right angle, the tab positioned opposite from the first hinge; and
a second hinged section including a second hinge that rotatably joins the second hinged section to the first hinged section and an upturned edge positioned opposite the second hinge,
wherein the breach tool is configured to be pushed under the door along a floor such that the first and second hinged sections pass from a second side to the first side and the second hinge engages a locking feature of the supplemental door lock, raising the locking feature to unlock the supplemental door lock.

2. The breach tool of claim 1, wherein the breach tool is configured to be placed on the floor such that the tab contacts the floor.

3. The breach tool of claim 1, wherein the upturned edge is configured to contact a first component of the locking feature and the second hinge is configured to apply an upward force to a second component of the locking feature.

4. The breach tool of claim 3, wherein the first and second hinged sections are configured to rotate about the second hinge as the second hinge applies the upward force to the second component of the locking feature.

5. The breach tool of claim 3, wherein the first hinged section is configured to rotate about the first hinge as the second hinge applies the upward force to the second component of the locking feature.

6. The breach tool of claim 3, wherein the second hinge is configured to apply the upward force to the second component to raise the locking feature so that a bottom of the locking feature is above the floor.

7. The breach tool of claim 1, wherein the first and second hinges allow for the breach tool to be folded for storage.

8. A breach tool for unlocking a supplemental door lock mounted on a lower edge of a first side of a door, the breach tool comprising:
a handle section including a first panel and a second panel connected to the first panel at roughly a right angle;
a first hinged section including a first hinge that rotatably joins the first hinged section to the first panel of the handle section and a tab extending outward from the first hinged section at roughly a right angle, the tab positioned opposite from the first hinge; and
a second hinged section including a second hinge that rotatably joins the second hinged section to the first hinged section and an upturned edge positioned opposite the second hinge,
wherein the breach tool is configured to be pushed under the door along a floor such that the first and second hinged sections pass from a second side to the first side,
the upturned edge is configured to contact a first component of the locking feature and the second hinge is configured to apply an upward force to a second component of the locking feature,
the first and second hinged sections are configured to rotate about the second hinge as the second hinge applies the upward force to the second component of the locking feature, and
the first hinged section is configured to rotate about the first hinge as the second hinge applies the upward force to the second component of the locking feature.

9. The breach tool of claim 8, wherein the second hinge is configured to apply the upward force to the second component to raise the locking feature so that a bottom of the locking feature is above the floor.

10. The breach tool of claim 8, wherein the first and second hinges allow for the breach tool to be folded for storage.

11. A supplemental door lock and breach tool system comprising:
a supplemental door lock including:
a door-mounted component configured to be mounted on a door adjacent to a lower edge thereof, the door-mounted component including:
a locking assembly for locking the supplemental door lock, the locking assembly including:
a hinge pin configured to be rotated between an unlocked position and a locked position,
a locking blade including a tab along a first edge of the locking blade, the tab attached to the hinge pin, the locking blade configured to travel downward into a locking groove when the hinge pin is rotated from the unlocked position to the locked position, and
a locking post attached to the locking blade along a second edge opposite the hinge pin, the locking post oriented in a vertical fashion and extending downward from the locking blade, and
a floor-mounted component to be mounted on a floor in alignment with the door-mounted component when the door is in a closed position, the floor-mounted component including:
a floor plate configured to attach to the floor, and
a slot configured to retain the locking post when the hinge pin is in the locked position; and
a breach tool for unlocking the supplemental door lock, the breach tool including:
a handle section including a first panel and a second panel connected to the first panel at roughly a right angle;
a first hinged section including a first hinge that rotatably joins the first hinged section to the first panel of the handle section and a tab extending outward from the first hinged section at roughly a right angle, the tab positioned opposite from the first hinge; and
a second hinged section including a second hinge that rotatably joins the second hinged section to the first hinged section and an upturned edge positioned opposite the second hinge,
wherein the breach tool is configured to be pushed under the door along a floor such that the first and second hinged sections pass from a second side to the first side and the second hinge engages a locking feature of the supplemental door lock, raising the locking feature to unlock the supplemental door lock.

12. The supplemental door lock and breach tool system of claim 11, wherein the breach tool is configured to be placed on the floor such that the tab contacts the floor.

13. The supplemental door lock and breach tool system of claim 11, wherein the upturned edge is configured to contact a first component of the locking feature and the second hinge is configured to apply an upward force to a second component of the locking feature.

14. The supplemental door lock and breach tool system of claim 13, wherein the first and second hinged sections are configured to rotate about the second hinge as the second hinge applies the upward force to the second component of the locking feature and the first hinged section is configured to rotate about the first hinge as the second hinge applies the upward force to the second component of the locking feature.

15. The supplemental door lock and breach tool system of claim 13, wherein the second hinge is configured to apply the upward force to the second component to raise the locking feature so that a bottom of the locking feature is above the floor.

16. The supplemental door lock and breach tool system of claim 11, wherein the first and second hinges allow for the breach tool to be folded for storage.

17. The supplemental door lock and breach tool system of claim 11, wherein the door-mounted component of the supplemental door lock further includes:
a door-mounting plate configured to attach to the door, and
a hinge plate mounted on an outer surface of the door-mounting plate, the hinge plate including an upper bridge and a lower bridge, each bridge including first and second roughly planar sections which are joined by an arcuate section such that an upper space and a lower space are formed underneath the arcuate sections, the lower bridge including a V-shaped groove,
and wherein the hinge pin is positioned in the upper space and the lower space, and the locking blade is configured to travel downward into the V-shaped groove when the hinge pin is rotated from the unlocked position to the locked position.

18. The supplemental door lock and breach tool system of claim 17, wherein the door-mounting plate further includes a foot extending outward from a lower edge of the door-mounting plate to prevent the hinge pin from extending into a gap between the door and the floor.

19. The supplemental door lock and breach tool system of claim 17, wherein the hinge plate further includes a support arm extending outward therefrom to form a second vertical slot in which the locking blade is retained when the hinge pin is in the unlocked position.

20. The supplemental door lock and breach tool system of claim 17, wherein the locking blade further includes an inner slanted edge coupled to a vertical edge adjacent to the hinge pin and positioned below a lower edge of the hinge pin, the inner slanted edge configured to be engaged by the upturned edge when the breach tool is utilized to unlock the supplemental door lock.
